(19) United States
(12) Patent Application Publication
(10) Pub. No.: US 2011/0170983 A1
(43) Pub. Date: Jul. 14, 2011

(54) PLAYSET FASTENER

(75) Inventors: Randall Lee Day, Lamar, MO (US); Daniel Ray Whyman, Lamar, MO (US)

(73) Assignee: BACKYARD LEISURE HOLDINGS, INC., Pittsburg, KS (US)

(21) Appl. No.: 12/687,582

(22) Filed: Jan. 14, 2010

(51) Int. Cl. F16B 35/00; A63G 31/00

(52) U.S. Cl. 411/370; 472/137

(57) ABSTRACT

A ratcheting fastener assembly is operable to be secured to an object and includes a rotatable threaded fastener and a ratchet element. The rotatable threaded fastener includes a serrated ratchet head and a threaded fastener body extending axially from the ratchet head. The ratchet element is in ratcheting engagement with the head and includes an annular element frame and at least one tooth operable to engage the object to restrict element rotation. The ratchet element also includes a plurality of circumferentially spaced pawls. The pawls and corresponding serrations rotatably ratchet relative to each other when the fastener is rotated in a tightening direction and engage each other when the head is rotated in a loosening direction.

### BACKGROUND

1. Field

The present invention relates generally to fasteners. More specifically, embodiments of the present invention concern a children's playset and a fastener to be used with a playset.

2. Discussion of Prior Art

Locking fasteners are well known in the prior art. For instance, it is known in the art to use complementally threaded fasteners, such as a threaded screw and nut, with a locking element designed to limit the threaded fasteners from being inadvertently unthreaded from each other. Conventional fastener locking elements include lock washers and thread-locking substances. Prior art lock washers operate as a spring to urge the screw and nut away from each other and thereby maintain an enhanced amount of frictional engagement between the threads of the screw and nut. Prior art lock washers also frictionally engage and thereby directly restrict rotation of the screw and/or nut.

Children's playsets are also conventional and often include a combination of modular playset components, such as a swing, slide, sandbox, or playhouse. Prior art modular playsets commonly include components that are interconnected by fasteners at component joints.

Prior art locking fasteners are deficient and have various limitations. For example, prior art locking fasteners allow ready loosening of the fastener. Prior art fasteners also allow the fastener to be loosened or otherwise altered in a manner that was not intended. While some fasteners include a head constructed to be engaged by a customized tool, the head can be modified to permit engagement with a standard tool.

Conventional playsets are also deficient and suffer from certain limitations. For instance, prior art playsets component joints are prone to loosening with extended playset use. In particular, it is known where relative cyclical movement between components can cause loosening or failure of the corresponding fasteners. Prior art playsets also permit tampering of the component joints (e.g., by purposely loosening the corresponding fasteners).

Accordingly, there is a need in the art for a locking fastener and playset that effectively prevents fastener loosening and tampering.

### SUMMARY

The following brief summary is provided to indicate the nature of the subject matter disclosed herein. While certain aspects of the present invention are described below, the summary is not intended to limit the scope of the present invention.

Embodiments of the present invention provide a playset and ratcheting fastener assembly that do not suffer from the problems and limitations of the prior art playsets and fasteners set forth above.

A first aspect of the present invention concerns a ratcheting fastener assembly operable to be secured to an object. The fastener assembly broadly includes a rotatable threaded fastener and a ratchet washer. The rotatable threaded fastener includes a serrated ratchet head and a threaded fastener body extending axially from the ratchet head. The ratchet head includes a plurality of axially projecting serrations spaced around the body, with adjacent serrations presenting a notch therebetween. The ratchet washer is in ratcheting engagement with the head and includes an annular washer frame that presents opposite washer sides. The ratchet washer includes at least one tooth that projects axially from one of the washer sides and is operable to engage the object and restrict washer rotation when the fastener is rotated in either a tightening or loosening direction. The ratchet washer includes a plurality of circumferentially spaced pawls that project axially from the other of the washer sides. The pawls are received in corresponding notches. The pawls and corresponding serrations rotatably ratchet relative to each other when the fastener is rotated in the tightening direction to permit relative rotation between the fastener and washer. The pawls and corresponding serrations engage each other when the head is rotated in the loosening direction to restrict relative rotation between the fastener and washer.

A second aspect of the present invention concerns a playset broadly including first and second structural members and a ratcheting fastener assembly. The first and second structural members are positioned adjacent each other, with one of the members supporting the other member. The ratcheting fastener assembly is secured to the members and thereby holds the members in secured engagement with each other. The fastener assembly includes a rotatable threaded fastener with a serrated ratchet head and a threaded fastener body extending axially from the ratchet head. The threaded fastener body is attached relative to the first structural member. The ratchet head includes a plurality of axially projecting serrations spaced around the body, with adjacent serrations presenting a notch therebetween. The fastener assembly includes a ratchet element in ratcheting engagement with the head and includes a frame that presents opposite sides. The ratchet element includes at least one tooth that projects axially from one of the frame sides and engages the second structural member to restrict element rotation when the fastener is rotated in either a tightening or loosening direction. The ratchet element includes a plurality of circumferentially spaced pawls that project axially from the other of the frame sides. The pawls are received in corresponding notches. The pawls and corresponding serrations rotatably ratchet relative to each other when the fastener is rotated in the tightening direction to permit relative rotation between the fastener and ratchet element. The pawls and corresponding serrations engage each other when the head is rotated in the loosening direction to restrict relative rotation between the fastener and ratchet element.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a perspective of a children's playset constructed in accordance with a preferred embodiment of the present invention, with the playset including a tower and a slide, where the tower includes a base, an elevated enclosure, and gusset beams that interconnect the base and enclosure;

FIG. 2 is an enlarged fragmentary perspective of the children's playset shown in FIG. 1, showing a deck, stanchions, and front and left side panels of the elevated enclosure and a forward gusset beam attached to a front left stanchion, with the deck including a deck support that interconnects left side stanchions and has upright and lateral support boards fastened together with single- and dual-socket ratcheting deck fastener assemblies, with part of the left side panel and part of the deck being broken away to show the ratcheting deck fastener assemblies;

FIG. 3 is an enlarged fragmentary side elevation of the children's playset shown in FIGS. 1 and 2, showing part of the front left stanchion, deck, front and left side panels, slide, and forward gusset beam, and showing the panels, deck, and forward gusset beam attached to the front left stanchion with ratcheting panel fastener assemblies;

FIG. 4 is an enlarged and exploded front perspective of the ratcheting panel fastener assembly shown in FIGS. 1-3, with the assembly including a wood screw having a serrated head and a star washer with projections operable to engage the head;

FIG. 5 is an opposite perspective of the ratcheting panel fastener assembly shown in FIG. 4;

FIG. 6 is a greatly enlarged fragmentary front perspective of the ratcheting panel fastener assembly shown in FIGS. 1-5, showing the star washer received on a shank of the wood screw, with the head serrations defining notches and washer projections including a plurality of pawls received by corresponding notches;

FIG. 7 is an enlarged and exploded fragmentary front perspective of the dual-socket ratcheting deck fastener assembly shown in FIGS. 1-3, showing a male machine screw and star washer, with the male machine screw having a serrated head and the star washer having projections operable to engage the head;

FIG. 8 is an enlarged and exploded rear perspective of the male machine screw and star washer shown in FIG. 7;

FIG. 9 is a greatly enlarged front perspective of the male machine screw and star washer shown in FIGS. 7 and 8, showing the star washer received on a shank of the machine screw, with the head serrations defining notches and washer projections including a plurality of pawls received by corresponding notches;

FIG. 10 is an enlarged and exploded fragmentary front perspective of the dual-socket ratcheting deck fastener assembly shown in FIGS. 1-3, showing a female machine screw and star washer, with the female machine screw having a serrated head and the star washer having projections operable to engage the head;

FIG. 11 is an enlarged and exploded rear perspective of the female machine screw and star washer shown in FIG. 10;

FIG. 12 is a greatly enlarged front perspective of the female machine screw and star washer shown in FIGS. 10 and 11, showing the star washer received on a shank of the machine screw, with the head serrations defining notches and washer projections including a plurality of pawls received by corresponding notches;

FIG. 13 is an enlarged cross section of the children's playset shown in FIGS. 1 and 2, showing a bracket of the forward gusset beam secured to the front left stanchion by a panel fastener assembly;

FIG. 14 is a cross section of the children's playset taken along line 14-14 in FIG. 3, showing lateral boards of the front and left side panels secured to the front left stanchion by panel fastener assemblies;

FIG. 15 is a cross section of the children's playset taken along line 15-15 in FIG. 3, showing an angle beam of the deck support fastened to upright and lateral support boards with single- and dual-socket ratcheting deck fastener assemblies; and

FIG. 16 is an enlarged fragmentary front perspective of the single-socket ratcheting deck fastener assembly shown in FIGS. 1-3, showing a female machine screw, with the female machine screw having a toothed head.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

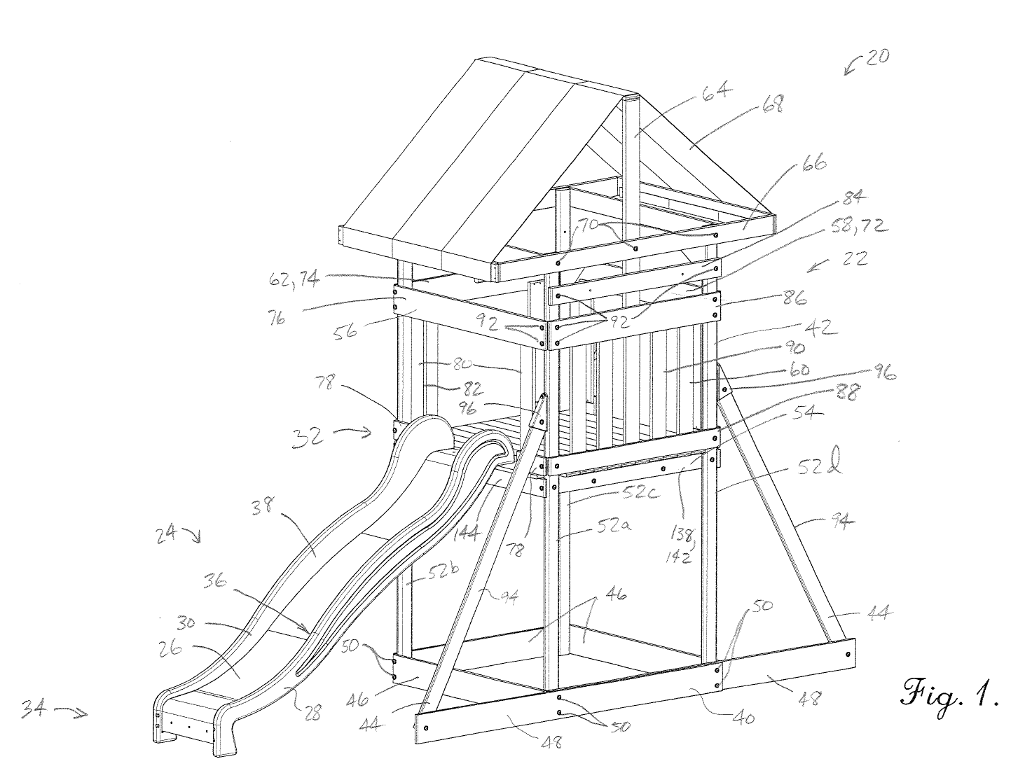

Turning initially to FIG. 1, a children's playset 20 is operable to be erected on a surface, such as the ground, and broadly includes a tower 22 and a slide 24. As will be discussed in greater detail, the playset 20 includes fasteners to securely interconnect components of the playset 20 to one another. Specifically, the fasteners are constructed to be fastened to the playset components in a fastened condition so that the fasteners are restricted from being removed. The illustrated playset fasteners are configured to restrict fastener removal that is either purposeful or inadvertent (e.g., due to relative movement between fastened playset components). For some aspects of the present invention, the illustrated playset 20 could be constructed for use in an alternative application, e.g., for other recreational uses.

Turning again to FIG. 1, the slide 24 provides a surface to carry a child between the tower 22 and the ground. The illustrated slide 24 preferably includes a slide bottom 26 and sides 28,30 that extend between upper and lower ends 32,34 of the slide 24. The sides 28,30 present inner slide surfaces 36,38 that each include an elongated groove extending between the ends 32,34. The slide bottom 26 comprises a unitary panel that extends along an undulating longitudinal path. The slide bottom 26 presents side edges that are received in corresponding grooves of the sides 28,30. The assembled slide 24 forms a substantially rigid construction. Additional details concerning the illustrated slide 24 are disclosed in pending U.S. application Ser. No. 11/776,442, filed Jul. 11, 2007, entitled PLAY SET SLIDE, which is hereby incorporated in its entirety by reference herein. It is also within the ambit of the present invention where the playset 20 includes another slide, such as an adjustable-height slide disclosed in pending U.S. application Ser. No. 12/577,610, filed Oct. 10, 2009, entitled ADJUSTABLE HEIGHT SLIDE BASE, which is hereby incorporated in its entirety by reference herein. As will be discussed, the upper end 32 of slide 24 is attached to a deck of the tower 22 and the lower end 34 is supported on the ground.

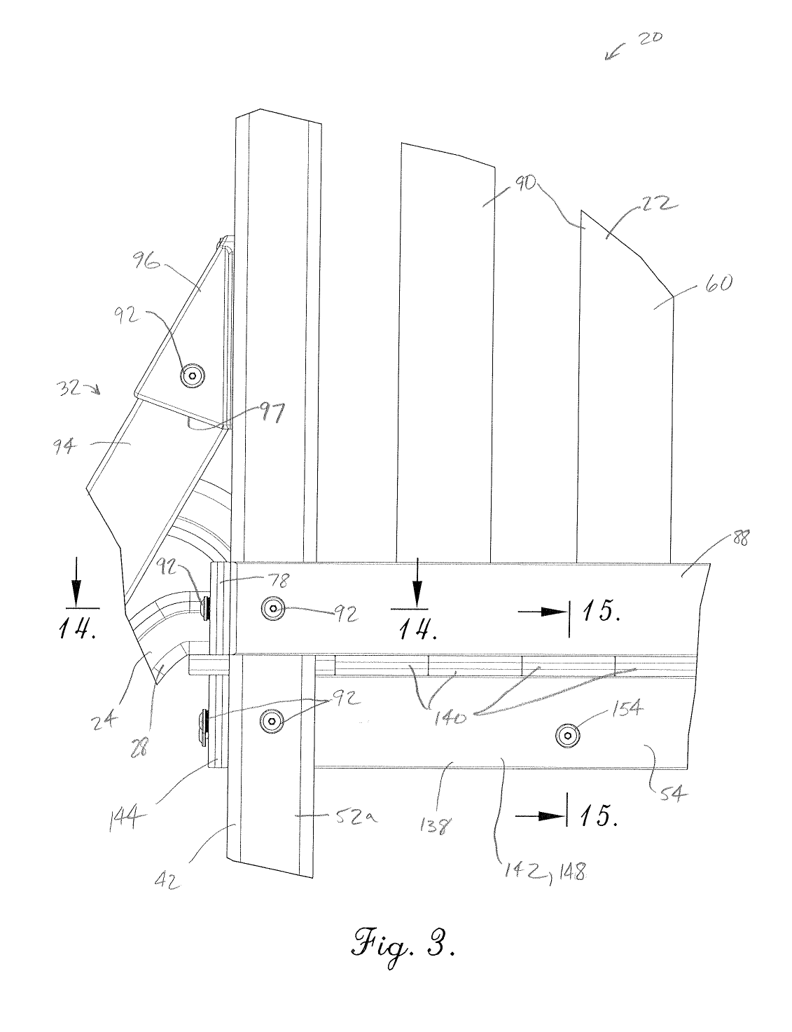

Turning to FIGS. 1-3, the tower 22 provides upper and lower play areas and is operable to support the upper end 32 of the slide 24. The tower 22 broadly includes a tower base 40, an elevated enclosure 42, and gusset beams 44. The boards used to construct the tower 22 are preferably made from wood, but could include other materials, such as synthetic resin, without departing from the scope of the present invention. As will be discussed in greater detail, the illustrated tower 22 includes a plurality of ratcheting fastener assemblies to secure tower components to one another.

The tower base 40 includes a plurality of side boards 46 that are fastened together to present sides of a box structure (e.g., for use as a sandbox) and outrigger boards 48 that project outwardly from opposite sides of the box structure. Boards 46,48 are secured by a plurality of base ratchet fastener assemblies 50, which will be discussed in greater detail. The principles of the present invention are applicable where base 40 has an alternative construction. Furthermore, for some aspects of the invention, the tower 22 could be devoid of the tower base 40.

The illustrated enclosure 42 includes upright elongated stanchions 52a,b,c,d that present upper and lower stanchion ends, with the lower stanchion ends being attached to respective corners of the box structure. The enclosure 42 further includes a deck 54, front panel 56, rear panel 58, left panel 60, right panel 62, and roof 64 that interconnect the stanchions 52. The roof 64 preferably includes a roof frame 66 and a flexible cover 68 supported by the frame 66. The frame 66 is secured to stanchions 52 with roof ratchet fastener assemblies 70.

The rear and right panels 58,62 include corresponding lateral braces 72,74 that extend between and interconnect respective stanchions 52. The panels 58,62 also include upright slats attached to the braces 72,74. The front panel 56 includes lateral braces 76,78 that extend between and interconnect respective stanchions 52. The front panel 56 also includes upright slats 80 that interconnect the braces 76,78. The lateral brace 76, slats 80, and deck 54 cooperatively present an opening 82 that receives the upper end 32 of the slide 24.

The left panel 60 includes lateral braces 84,86,88 that extend between and interconnect corresponding stanchions 52. The left panel 60 also includes upright slats 90 that are spaced uniformly along and interconnect the braces 86,88. The panels 56,58,60,62 are fastened to the stanchions 52 with panel ratchet fastener assemblies 92, as will be discussed further.

The gusset beams 44 each interconnect a corresponding stanchion 52 and outrigger board 48. The gusset beams 44 include a board 94 with upper and lower ends and a bracket 96 attached to the upper end of the board 94. The bracket 96 is preferably formed of metal, although other suitable materials are certainly within the ambit of the present invention. The bracket 96 presents a lower opening 97 that receives the upper end of board 94. The bracket 96 also presents a countersunk hole 98. The lower end of board 94 is attached to the outrigger board 48 with one of the base ratchet fastener assemblies 50. The bracket 96 is secured within the lower opening 97 with a panel ratchet fastener assembly 92. Also, the bracket 96 is secured to the stanchion 52a by extending another panel ratchet fastener assembly 92 through the hole 98 and into the stanchion 52a (see FIG. 13).

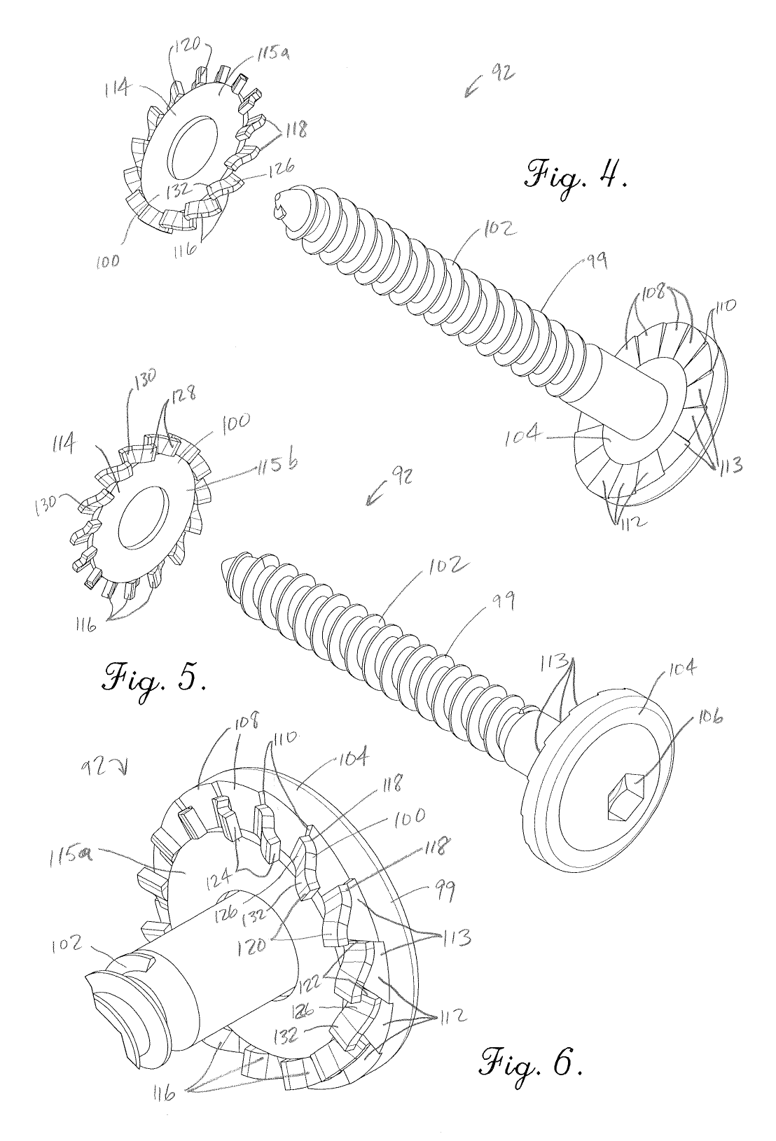

Turning to FIGS. 4-6, the panel ratchet fastener assembly 92 is constructed to be rotated in a tightening rotational direction into secure engagement with a substrate. Furthermore, the panel ratchet fastener assembly 92 is constructed to restrict rotation in a loosening rotational direction when located in the fastened condition in secure engagement with the substrate. The illustrated panel ratchet fastener assembly 92 preferably includes a wood screw 99 and a star washer 100. The screw 99 and washer 100 are preferably formed of a suitable metal, e.g., stainless steel, although other materials fall within the scope of the present invention.

The wood screw 99 includes an axially-extending externally-threaded body 102 that extends in a forward direction from a shank end to a tap end. The threaded body 102 preferably comprises a self-tapping screw. It is also within the scope of the present invention where the ratcheting fastener assembly includes an alternative screw body, such as a machine screw body, as will be discussed further. While the illustrated body 102 has right-hand threads, it is within the ambit of the present invention where the body 102 has left-hand threads.

The wood screw 98 also preferably includes a head 104 presenting a socket 106 on a socket side of the head 104 and a plurality of circumferentially spaced serrations 108 on the opposite shank side. The illustrated serrations 108 preferably project radially inwardly from the circumferential margin of the head 104 so that the serrations 108 present an annular serrated face.

Each serration 108 presents a locking serration flat 110 and a serration cam surface 112 that meet at a radial edge. The serration flat 110 extends substantially parallel to the fastener axis. As will be discussed in greater detail, the flats 110 are configured to engage corresponding flats of the washer 100. Each cam surface 112 extends from the radial edge to an adjacent flat 110 in a counterclockwise circumferential direction when the wood screw 98 is viewed from the front. The cam surface 112 also extends in an aft direction from the radial edge so as to intersect the adjacent flat 110 at a base thereof. Thus, each cam surface 112 lies generally in a plane that is preferably at an acute angle relative to the fastener axis. While the cam surfaces 112 preferably extend from the radial edge in the counterclockwise direction when viewed from the front, it is also within the scope of the present invention where the cam surfaces 112 extend in a clockwise direction when viewed from the front, e.g., where the body 102 has left-hand threads. The cam surface 112 is operable to engage corresponding surfaces of the washer 100.

Adjacent pairs of serrations 108 each cooperatively present a notch 113 therebetween that is operable to receive a respective pawl of the washer 100, as will be discussed. In the usual manner, the head 104 is integrally formed with the body 102 so that the shank end of the body 102 is fixed to the shank side of the head 104 and the body 102 extends axially from the head 104.

As will be discussed, the star washer 100 serves to engage the substrate and the socket head 104 to restrict loosening rotation of the screw 98. The illustrated washer 100 preferably includes an annular washer body 114 and a plurality of circumferentially-spaced radial projections 116. The washer body 114 preferably comprises an endless construction and presents substantially flat sides 115a,b.

The illustrated projections 116 are preferably unitary and each include a pawl 118 configured to appropriately engage the serrations 108 and a substrate-engaging tooth 120. In particular, each integrally formed pawl 118 and tooth 120 project circumferentially away from each other to present a pawl flat 122 and tooth flat 124, respectively (see FIG. 6). Each pawl 118 further presents opposite inner and outer pawl faces 126,128 that extend from the tooth 120 to the pawl flat 122 and present a scalloped profile along the circumferential direction. Similarly, each tooth 120 presents opposite inner and outer tooth faces 130,132 that extend from the pawl 118 to the tooth flat 124 and present a scalloped profile along the circumferential direction.

The pawls 118 and teeth 120 are preferably substantially identical in shape. However, the principles of the present invention are applicable where pawls 118 have a different shape than teeth 120, e.g., so that the teeth 120 are constructed to securely engage an adjacent substrate.

The projections 116 are preferably attached to an outermost circumferential margin of the body 114 and project radially outwardly from the body 114. The illustrated projections 116 are arranged so that the pawls 118 project in one axial direction from the side 115b of body 114 and the teeth 120 project in the opposite axial direction from the other side 115a of body 114. Furthermore, the projections 116 are preferably uniformly spaced about the circumferential margin. While washer 100 preferably has the same number of pawls 118 and teeth 120, it is also within the scope of the present invention where the washer has different numbers of pawls 118 and teeth 120. For instance, the washer 100 preferably includes at least one tooth 120 so that the washer 100 is operable to mechanically engage a substrate to restrict washer rotation.

The washer 100 is received onto the screw 98 by inserting the body 102 through a central hole of the washer body 114. The washer 100 is arranged so that the pawls 118 are in ratcheting engagement with serrations 108. Preferably, the number of pawls 118 is identical to the number of notches 113 so that each pawl 118 can be received by a corresponding notch 113. However, for some aspects of the present invention, the number of pawls 118 could be greater or lesser than the number of notches 113.

The pawls 118 and serrations 108 are in ratcheting engagement with each other to permit rotation of the screw 98 relative to the washer 100 in the tightening rotational direction and restrict rotation of the screw 98 relative to the washer 100 in the loosening rotational direction. The screw 98 preferably has right-hand threads so that the tightening rotational direction of the screw 98 is clockwise about the screw axis when viewing the screw 98 from the rear (i.e., viewing the screw along the forward direction). Thus, the loosening direction is counterclockwise about the screw axis when viewing the screw 98 from the rear. However, the principles of the present invention are applicable where the screw 98 has left-hand threads that result in a counterclockwise tightening direction and a clockwise loosening direction. When the screw 98 rotates in sliding engagement with washer 100 in the tightening direction, cam surfaces 112 slide along corresponding outer pawl faces 128, which also serve as cam surfaces.

The screw 98 and washer 100 are also relatively positioned so that serration flats 110 and pawl flats 122 face in substantially opposed circumferential directions. Thus, when the pawls 118 engage corresponding serrations 108, serration flats 110 engage corresponding pawl flats 122 to restrict relative rotation between the screw 98 and washer 100.

As will be discussed, the teeth 120 are constructed to frictionally engage a substrate when the fastener assembly 92 is threaded into the substrate. In particular, the teeth 120 are preferably constructed to permit rotation of the fastener assembly 92 relative to the substrate in the tightening rotational direction so that the fastener assembly 92 can be installed into a fastened condition. The teeth 120 are also constructed to restrict rotation of the screw 98 relative to the substrate out of the fastened condition. Specifically, the teeth 120 frictionally engage the substrate when the fastener assembly 92 is rotated in the loosening rotational direction, and in instances when the substrate includes a material softer than the washer, the flats 124 of teeth 120 can dig into and mechanically engage the substrate.

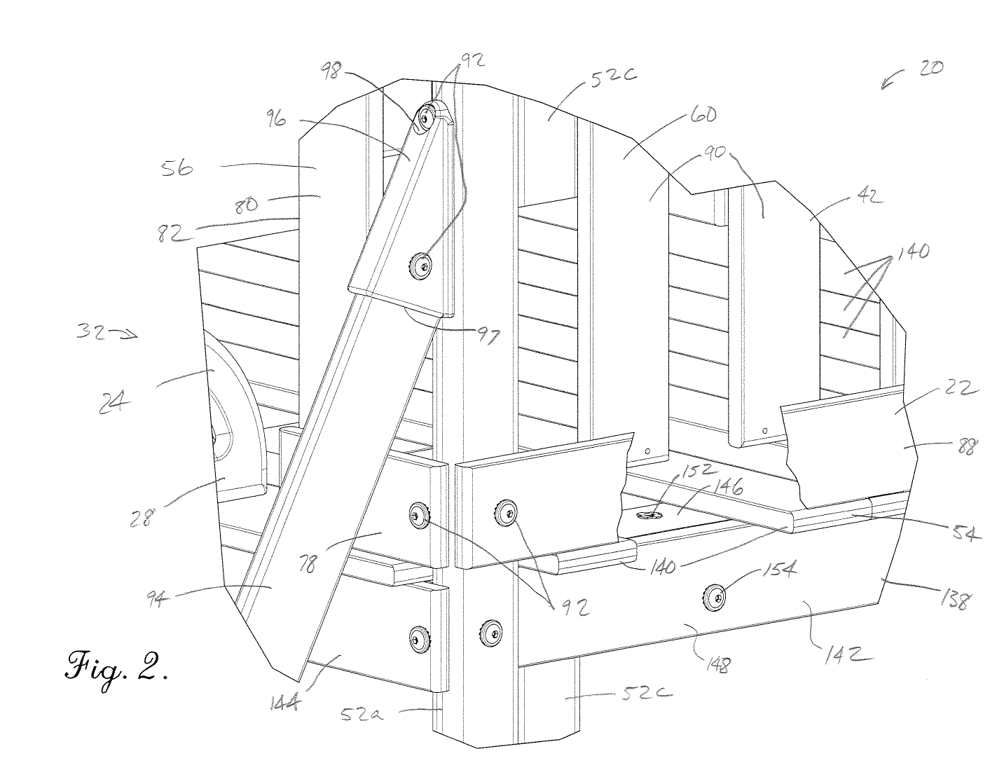

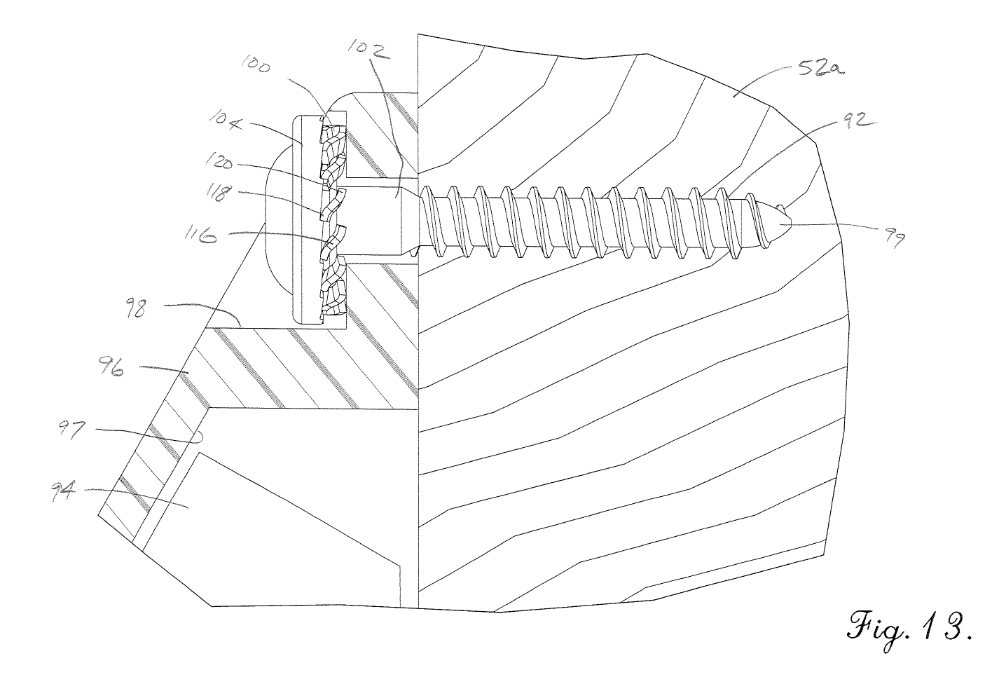

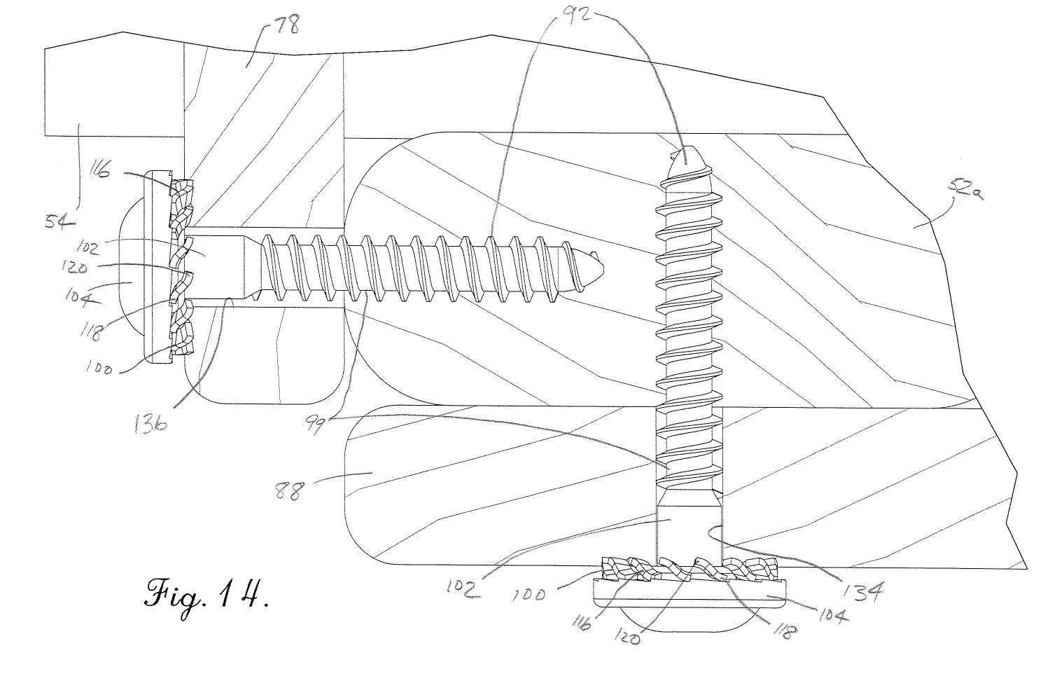

Turning to FIGS. 2, 3, and 14, ratchet fastener assemblies 92 preferably secure the front and left panels 56,60 to the stanchion 52a. For example, lateral brace 88 is attached adjacent a left side of stanchion 52a by inserting one of the fastener assemblies 92 through a slightly oversized hole 134 of the brace 88 and threading the fastener assembly 92 into the stanchion 52a (see FIG. 14). Lateral brace 78 of front panel 56 is attached adjacent a front edge of stanchion 52a by inserting another one of the fastener assemblies 92 through an oversized hole 136 of the brace 78 and threading the another fastener assembly 92 into the stanchion 52a. In the illustrated embodiment, the secured fastener assemblies 92 are rotatably tightened into the fastened condition so that the teeth 120 frictionally engage and dig into the material of the braces 78,88 to provide mechanical engagement with the braces.

As the tightened screw 98 is rotated in the loosening rotational direction, the serration flats 110 engage corresponding pawl flats 122 to restrict relative rotation between the screw 98 and washer 100. Thus, loosening rotation of the screw 98 causes rotation of the washer 100 in the loosening direction. Because the tooth flats 124 generally point in the loosening direction, the flats 124 dig into the substrate material and restrict further loosening rotation when the washer is rotated in the loosening direction. Consequently, loosening rotation of the screw 98 causes the washer 100 to dig into and mechanically engage the substrate to hold the fastener assembly 92 in the fastened condition.

Turning to FIGS. 2, 3, and 13, ratchet fastener assemblies 92 secure the metal bracket 96 to board 94 and to stanchion 52a. In particular, the fastener assemblies 92 frictionally engage the corresponding metal surfaces of bracket 96 when the fastener assemblies 92 are rotatably tightened in the fastened condition. For instance, the fastener assembly 92 received by countersunk hole 98 has a washer 100 with teeth 120 that frictionally engage the shoulder of the hole 98 (see FIG. 13). The fastener assembly 92 that secures the board 94 within the bracket 96 has a washer 100 with teeth 120 that frictionally engage a sidewall of the bracket 96. In the illustrated fastened condition, loosening rotation of the screws 98 secured to the bracket 96 causes rotation of the corresponding washers 100 in the loosening direction. The respective tooth flats 124 point in the loosening direction and frictionally engage the bracket 96. In the illustrated embodiment, the bracket 96 and washers 100 preferably include respective metal materials with corresponding hardness values so that the flats 124 substantially do not dig into the bracket substrate but frictionally engage the bracket 96.

The ratchet fastener assemblies 50,70,92 are preferably substantially identical to one another. However, it is also within the scope of the present invention where assemblies 50,70,92 have different configurations, e.g., different materials, fastener sizes, or fastener types, for securing respective playset components.

Turning to FIGS. 1-3 and 15, the deck 54 is located above the base 40 to provide the upper play area. The deck 54 also receives and supports the upper end 32 of slide 24 adjacent the opening 82. The deck 54 includes a frame 138 attached to the stanchions 52 and a plurality of planks 140 mounted on top of the frame 138. The frame 138 includes reinforced side supports 142 and fore and aft end supports 144 that interconnect corresponding pairs of stanchions 52.

The side support 142 includes lateral and upright boards 146,148 and an angle beam 150. The angle beam 150 is elongated and is preferably made of carbon steel, but could include other metal materials such as aluminum or stainless steel. The beam 150 presents a substantially continuous L-shaped cross section, with lateral and upright beam portions arranged at a right angle to one another and positioned adjacent to corresponding boards 146,148.

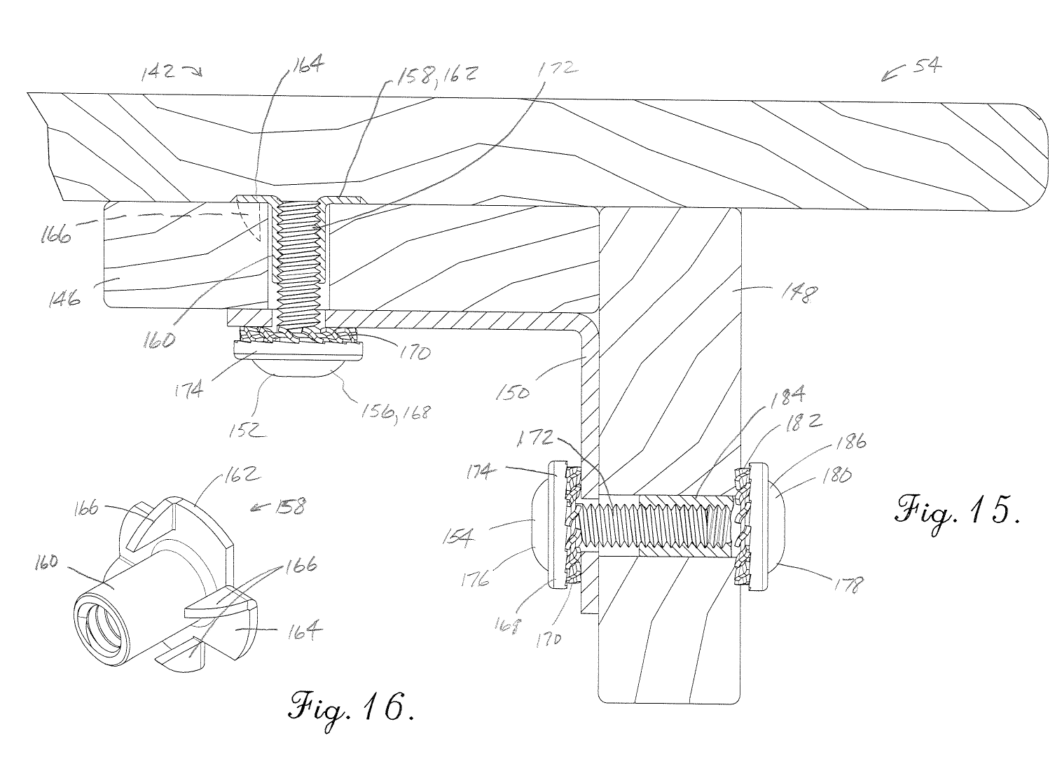

The boards 146,148 are connected to corresponding portions of the beam 150 by respective ratcheting fastener assemblies 152,154. Fastener assembly 152 includes a ratcheting male fastener 156 and a female fastener 158 (see FIG. 15). The female fastener 158 includes an internally-threaded body 160 and a toothed flange 162 attached to one end of the body 160, with the flange 162 including a base 164 and four (4) teeth 166 projecting axially from the base 164 toward the other end of the body 160 (see FIG. 16).

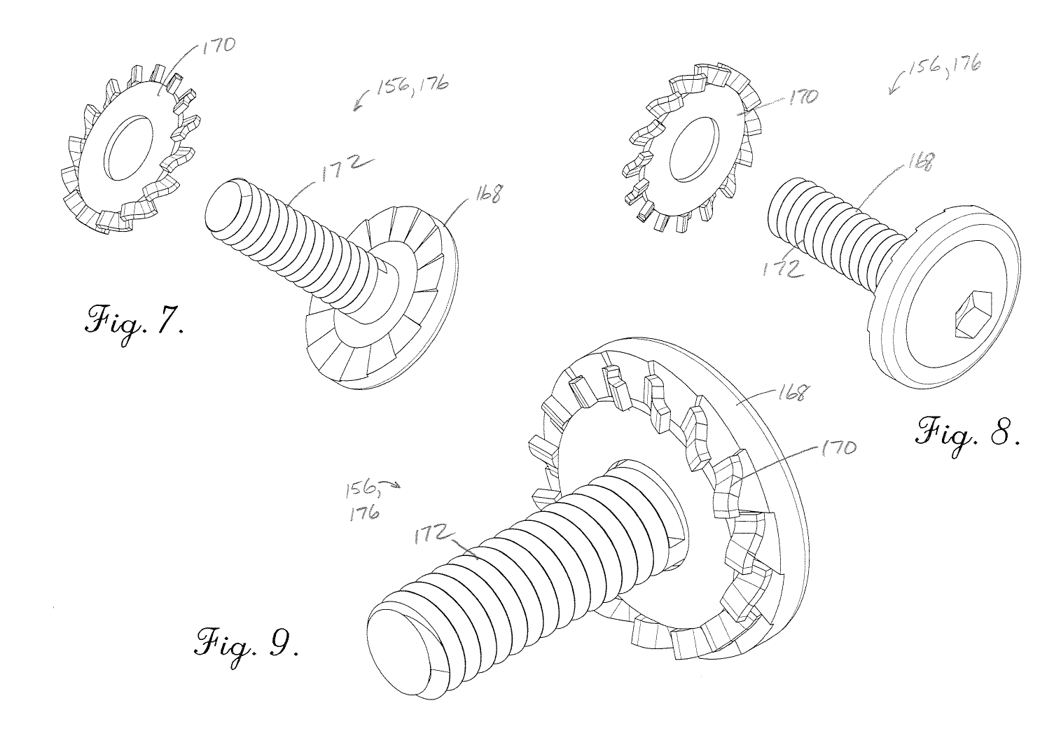

Turning to FIGS. 7-9 and 15, the male fastener 156 includes a machine screw 168 and a star washer 170. The machine screw 168 includes an externally-threaded body 172 and a head 174 substantially identical to head 104. The washer 170 is substantially identical to washer 100 and is received on the body 172 in sliding engagement with the head 174.

In the illustrated embodiment, the machine screw 168 is inserted into aligned holes of the board 146 and beam 150, with the head 174 positioned adjacent the beam 150. The female fastener 158 is inserted into the corresponding hole of board 146 so that teeth 166 penetrate into the board 146. Thus, the head 174 and flange 162 are opposed to each other, with the male fastener 156 having a first tightening direction and the female fastener 158 having a second tightening direction opposite the first tightening direction. While the illustrated female fastener 158 is removably attached to board 146, it is also within the scope of the present invention where female fastener 158 is captively secured to board 146.

As the fasteners 156,158 are rotatably tightened into a fastened condition by rotating at least one of the fasteners 156,158 in the respective tightening direction, the head 174 slidably engages the washer 170 and the washer 170 frictionally engages the beam 150.

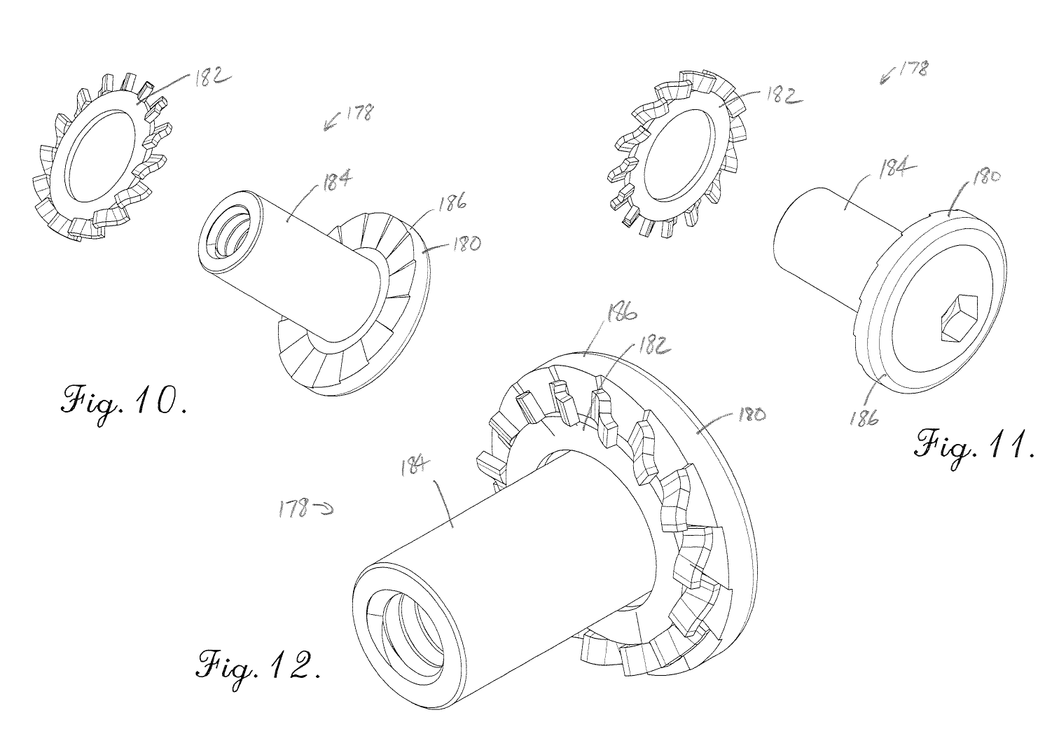

Turning to FIGS. 7-12 and 15, the fastener assembly 154 includes a ratcheting male fastener 176 and a ratcheting female fastener 178. The female fastener 178 includes a female screw 180 and a washer 182. The screw 180 includes an internally-threaded body 184 and a head 186 substantially identical to head 174. The washer 182 is substantially identical to washer 170, except for having a relatively larger central hole, and is received on body 184 in sliding engagement with head 186. The male fastener 176 includes another machine screw 168 and another star washer 170.

In the illustrated embodiment, the machine screw 168 of fastener 176 is inserted into aligned holes of the board 148 and beam 150, with the head 174 positioned adjacent the beam 150. The female fastener 178 is inserted into the corresponding hole of board 148, with head 186 positioned adjacent board 148. Thus, the heads 174,186 are opposed to each other, with the male machine screw 168 having a first tightening direction and the female screw 180 having a second tightening direction opposite the first tightening direction.

As the fasteners 176,178 are rotatably tightened into a fastened condition by rotating at least one of the fasteners 156,158 in the respective tightening direction, the heads 174,186 slidably engage the corresponding washers 170,182 and the washers 170,182 frictionally engage the board 148 and beam 150, respectively.

The illustrated fastener assemblies 152,154 have been found to particularly minimize the number of fasteners needed for securement of variously-sized members. Specifically, the combination of male and female fasteners allows a single type of female fastener to be used with male fasteners of various lengths.

It has also been found that the illustrated construction of fastener assemblies 50,70,92, 152,154 provide enhanced fastening securement of playset members such that fewer screw diameters are required, i.e., such that the fastener does not have to be oversized in order to restrict fastener removal. This is particularly useful in playset applications where the sizes of fasteners are limited by industry standards so as to avoid risking injury to children.

The illustrated ratchet fastener assemblies 50,70,92,152,154 preferably include a ratcheting washer removably received on the corresponding ratcheting screw. But it is also within the ambit of the present invention where the ratcheting washer is captively rotatably mounted on the screw body (i.e., where the washer is not removable from the screw by simply sliding the washer off the screw body). Alternatively, for some aspects of the present invention, the ratcheting washer could be captively secured to the corresponding board of the playset (e.g., where the ratcheting washer is in the form of a plate or endless band secured to the board).

In use, the ratchet fastener assemblies secure members of the playset 20 to one another and restrict separation of the members. The threaded ratchet screw is rotatably tightened into a member by rotating the screw counterclockwise, with the ratchet washer being slidably received on the screw. As the screw is tightened, the serrations of the screw head are operable to slide along pawls of the ratchet washer. Furthermore, the illustrated washers include teeth that frictionally engage, and in some instances mechanically engage, the corresponding member to restrict washer rotation as the fastener assembly is located in the fastened condition.

Loosening rotation of the fastener assembly is restricted by the fastener construction when the fastener assembly is in the fastened condition. In particular, the toothed washer restricts washer rotation in either rotational direction. Furthermore, counterclockwise loosening rotation of the screw relative to the washer is restricted by engaged pairs of serrations and pawls. Thus, the screw, washer, and the corresponding member cooperatively restrict loosening of the fastener.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A ratcheting fastener assembly operable to be secured to an object, said fastener assembly comprising:
a rotatable threaded fastener including a serrated ratchet head and a threaded fastener body extending axially from the ratchet head,
said ratchet head including a plurality of axially projecting serrations spaced around the body, with adjacent serrations presenting a notch therebetween; and
a ratchet washer in ratcheting engagement with the head and including an annular washer frame that presents opposite washer sides,
said ratchet washer including at least one tooth that projects axially from one of the washer sides and is operable to engage the object and restrict washer rotation when the fastener is rotated in either a tightening or loosening direction,
said ratchet washer including a plurality of circumferentially spaced pawls that project axially from the other of the washer sides,
said pawls being received in corresponding notches,
said pawls and corresponding serrations rotatably ratcheting relative to each other when the fastener is rotated in the tightening direction to permit relative rotation between the fastener and washer,
said pawls and corresponding serrations engaging each other when the head is rotated in the loosening direction to restrict relative rotation between the fastener and washer.

2. The ratcheting fastener assembly as claimed in claim 1,
said pawls and serrations presenting circumferentially extending cam surfaces that slidably engage one another and permit relative rotation between the fastener and washer in the tightening direction,
said pawls and serrations presenting opposed pawl and serration flats that face in opposed circumferential directions, with corresponding pawl and serration flats engaging each other to restrict relative rotation between the fastener and washer in the loosening direction.

3. The ratcheting fastener assembly as claimed in claim 1, each of said pawl cam surfaces presenting a convexly scalloped circumferential profile.

4. The ratcheting fastener assembly as claimed in claim 1,
said pawls being the same in number as the serrations so that each pair of adjacent serrations has a corresponding pawl located therebetween.

5. The ratcheting fastener assembly as claimed in claim 4,
said ratchet washer including a plurality of teeth that project axially from the one washer side.

6. The ratcheting fastener assembly as claimed in claim 5,
said teeth being the same in number as the pawls.

7. The ratcheting fastener assembly as claimed in claim 6,
said teeth and said pawls projecting radially outwardly from the annular washer frame, with corresponding pairs of teeth and pawls being integrally formed with each other.

8. The ratcheting fastener assembly as claimed in claim 1,
said threaded fastener comprising an externally-threaded screw with male threads.

9. The ratcheting fastener assembly as claimed in claim 1,
said threaded fastener comprising an internally-threaded barrel nut with female threads.

10. The ratcheting fastener assembly as claimed in claim 1; and
a second rotatable threaded fastener including a second head and a second threaded fastener body extending axially from the second head,
said threaded fastener bodies being threadably interengaged so that the heads are opposed to one another and a second tightening direction of the second fastener is opposite to the first-mentioned tightening direction, with tightening rotation of at least one of the heads operable to shift the heads toward each other and into securement on the object.

11. The ratcheting fastener assembly as claimed in claim 10,
said second head comprising a ratchet head,
said second ratchet head including a plurality of axially projecting second serrations spaced around the body, with adjacent second serrations presenting a second notch therebetween; and
a second ratchet washer in ratcheting engagement with the second ratchet head and including a second annular washer frame that presents opposite second washer sides,
said second ratchet washer including at least one tooth that projects axially from one of the washer sides and is operable to engage the object and restrict rotation of the second washer when the second fastener is rotated in either of second tightening or loosening directions,
said second ratchet washer including a plurality of circumferentially spaced second pawls that project axially from the other of the second washer sides,
said second pawls being received in corresponding second notches,
said second pawls and corresponding second serrations rotatably ratcheting relative to each other when the second fastener is rotated in the second tightening direction to permit relative rotation between the second fastener and second washer,
said second pawls and corresponding second serrations engaging each other when the second head is rotated in the second loosening direction to restrict relative rotation between the second fastener and second washer.

12. A playset comprising:
first and second structural members positioned adjacent each other, with one of the members supporting the other member; and
a ratcheting fastener assembly secured to the members and thereby holding the members in secured engagement with each other,
said fastener assembly including a rotatable threaded fastener with a serrated ratchet head and a threaded fastener body extending axially from the ratchet head,
said threaded fastener body being attached relative to the first structural member,
said ratchet head including a plurality of axially projecting serrations spaced around the body, with adjacent serrations presenting a notch therebetween,
said fastener assembly including a ratchet element in ratcheting engagement with the head and including a frame that presents opposite sides,
said ratchet element including at least one tooth that projects axially from one of the frame sides and engages the second structural member to restrict element rotation when the fastener is rotated in either a tightening or loosening direction,
said ratchet element including a plurality of circumferentially spaced pawls that project axially from the other of the frame sides,
said pawls being received in corresponding notches,
said pawls and corresponding serrations rotatably ratcheting relative to each other when the fastener is rotated in the tightening direction to permit relative rotation between the fastener and ratchet element,
said pawls and corresponding serrations engaging each other when the head is rotated in the loosening direction to restrict relative rotation between the fastener and ratchet element.

13. The playset as claimed in claim 12,
said pawls and serrations presenting circumferentially extending cam surfaces that slidably engage one another and permit relative rotation between the fastener and washer in the tightening direction,
said pawls and serrations presenting opposed pawl and serration flats that face in opposed circumferential directions, with corresponding pawl and serration flats engaging each other to restrict relative rotation between the fastener and washer in the loosening direction.

14. The playset as claimed in claim 12,
each of said pawl cam surfaces presenting a convexly scalloped circumferential profile.

15. The playset as claimed in claim 12,
said pawls being the same in number as the serrations so that each pair of adjacent serrations has a corresponding pawl located therebetween.

16. The playset as claimed in claim 15,
said ratchet element including a plurality of teeth that project axially from the one frame side.

17. The playset as claimed in claim 16,
said teeth being the same in number as the pawls.

18. The playset as claimed in claim 17,
said teeth and said pawls projecting radially outwardly from the frame, with corresponding pairs of teeth and pawls being integrally formed with each other.

19. The playset as claimed in claim 12,
said threaded fastener comprising an externally-threaded screw with male threads.

20. The playset as claimed in claim 12,
said threaded fastener comprising an internally-threaded barrel nut with female threads.

21. The playset as claimed in claim 12; and
a second rotatable threaded fastener including a second head and a second threaded fastener body extending axially from the second head,
said threaded fastener bodies being threadably interengaged so that the heads are opposed to one another and a second tightening direction of the second fastener is opposite to the first-mentioned tightening direction, with tightening rotation of at least one of the heads operable to shift the heads toward each other and into securement on the members.

22. The playset as claimed in claim 21,
said second head comprising a ratchet head,
said second ratchet head including a plurality of axially projecting second serrations spaced around the body, with adjacent second serrations each presenting a second notch therebetween; and
a second ratchet element in ratcheting engagement with the second ratchet head and including a second frame that presents opposite second frame sides,
said second ratchet element including at least one tooth that projects axially from one of the second frame sides and engages the first structural member to restrict rotation of the second ratchet element when the second fastener is rotated in either of second tightening or loosening directions,
said second ratchet element including a plurality of circumferentially spaced second pawls that project axially from the other of the second frame sides,
said second pawls being received in corresponding second notches,
said second pawls and corresponding second serrations rotatably ratcheting relative to each other when the second fastener is rotated in the second tightening direction to permit relative rotation between the second fastener and second ratchet element,
said second pawls and corresponding second serrations engaging each other when the second head is rotated in the second loosening direction to restrict relative rotation between the second fastener and second ratchet element.
